(19) United States
(12) Patent Application Publication
(10) Pub. No.: US 2026/0312716 A1
(43) Pub. Date: Oct. 8, 2026

(54) SUCCESSIVE CANCELLATION LIST DECODING OF POLAR CODES

(71) Applicant: Samsung Electronics Co., Ltd., Suwon-si (KR)

(72) Inventors: Heping Wan, Frisco, TX (US); Joonyoung Cho, Portland, OR (US)

(21) Appl. No.: 19/577,234

(22) Filed: Mar. 24, 2026

Related U.S. Application Data
(60) Provisional application No. 63/785,513, filed on Apr. 8, 2025.

(51) Int. Cl. H04L 1/00; H04L 41/14

(52) U.S. Cl. CPC H04L 1/0006; H04L 1/0009; H04L 1/0057; H04L 41/145

(57) ABSTRACT

An information set, a code length, and a set of entropy values for received polar code signals are obtained. A list size is adaptively changed based on an entropy-based metric for reducing a computational complexity of successive cancellation list (SCL) decoding and for maintaining error-correcting performance. A respective entropy-based metric is determined for each index in the information set for a polar code. A list size smaller than a specified list size is assigned to one or more indices that have metrics less than a specified metric amount to produce a dynamic list size allocation. The error-correcting performance is measured based on simulating a block error rates (BLER) across a range of signal to noise ratios (SNRs), based on a SNR gap being within 0.05 decibels (dB).

### CROSS-REFERENCE TO RELATED APPLICATION(S) AND CLAIM OF PRIORITY

This application claims priority under 35 U.S.C. § 119 (e) to U.S. Provisional Patent Application No. 63/785,513 filed on Apr. 8, 2025. The above-identified provisional patent applications are hereby incorporated by reference in their entirety.

### TECHNICAL FIELD

This disclosure relates generally to wireless networks. More specifically, this disclosure relates to polar codes for use in wireless communication networks.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

To meet the demand for wireless data traffic having increased since deployment of 4G communication systems, and to enable various vertical applications, 5th Generation (5G) communication systems have been developed and are currently being deployed. The enablers for the 5G/New Radio (NR) mobile communications include massive antenna technologies, from legacy cellular frequency bands up to high frequencies, to provide beamforming gain and support increased capacity, new waveforms (e.g., new radio access technologies (RATs)) to flexibly accommodate various services/applications with different requirements, new multiple access schemes to support massive connections, etc. The 5G communication system is considered to be implemented to include higher frequency (mmWave) bands, such as 28 giga-Hertz (GHz) or 60 GHz bands or, in general, above 6 GHz bands, so as to accomplish higher data rates, or in lower frequency bands, such as below 6 GHZ, to enable robust coverage and mobility support. Aspects of the present disclosure may be applied to deployment of 5G communication systems, 6th Generation (6G) or even later releases which may use terra-Hertz (THz) bands. To decrease propagation loss of the radio waves and increase the transmission distance, the beamforming, massive multiple-input multiple-output (MIMO), full dimensional MIMO (FD-MIMO), array antenna, an analog beam forming, large-scale antenna techniques are discussed in 5G communication systems.

In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-point (COMP) communication, reception-end interference cancellation, and the like.

### SUMMARY

This disclosure provides apparatuses and methods for adaptively changing a list size for SCL decoding, based on an entropy-based metric.

In an embodiment, a method is performed in a wireless communications system. The method includes receiving an information set, a code length, and a set of entropy values for received signals. The method also includes adaptively changing a list size based on an entropy-based metric for reducing a computational complexity of successive cancellation list (SCL) decoding and for maintaining error-correcting performance. The method further includes determining, for a polar code using the set of entropy values, a respective entropy-based metric for each index in the information set. The method still further includes assigning a list size smaller than a specified list size to one or more indices that have entropy-based metrics less than a specified entropy-based metric amount to produce a dynamic list size allocation.

In another embodiment, a user equipment (UE) is provided. The UE includes a transceiver configured to receive an information set, a code length, and a set of entropy values for received signals. The UE also includes at least one processing device coupled to the transceiver. The at least one processing device is configured to adaptively change a list size based on an entropy-based metric for reducing a computational complexity of successive cancellation list (SCL) decoding and for maintaining error-correcting performance. The at least one processing device is also configured to determine, for a polar code using the set of entropy values, a respective entropy-based metric for each index in the information set. The at least one processing device is further configured to assign a list size smaller than a specified list size to one or more indices that have entropy-based metrics less than a specified entropy-based metric amount to produce a dynamic list size allocation.

In yet another embodiment a base station (BS) is provided. The BS includes at least one processing device and a transceiver coupled to the at least one processing device. The transceiver is configured to receive an information set, a code length, and a set of entropy values for received signals. The at least one processing device is configured to adaptively change a list size based on an entropy-based metric for reducing a computational complexity of successive cancellation list (SCL) decoding and for maintaining error-correcting performance. The at least one processing device is also configured to determine, for a polar code using the set of entropy values, a respective entropy-based metric for each index in the information set. The at least one processing device is further configured to assign a list size smaller than a specified list size to one or more indices that have entropy-based metrics less than a specified entropy-based metric amount to produce a dynamic list size allocation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network for use of polar codes designed for successive cancellation list decoding based on entropy metrics according to embodiments of the present disclosure;

FIGS. 2A and 2B illustrate example wireless transmit and receive paths for use of polar codes designed for successive cancellation list decoding based on entropy metrics according to embodiments of the present disclosure;

FIG. 3A illustrates an example UE for use of polar codes designed for successive cancellation list decoding based on entropy metrics according to embodiments of the present disclosure;

FIG. 3B illustrates an example gNB for polar codes designed for successive cancellation list decoding based on entropy metrics according to embodiments of the present disclosure;

FIGS. 4A through 4H diagrammatically illustrate a polar code designed for successive cancellation list decoding based on entropy metrics in accordance with the present disclosure;

FIG. 5 illustrates, for the polar codes of the type in the example of FIGS. 4A through 4H, successive cancellation list decoding based on entropy metrics in accordance with the present disclosure;

FIG. 6 illustrates an example embodiment for creating a set of list sizes for an information set used with successive cancellation list decoding based on entropy metrics in accordance with the present disclosure;

FIG. 7 illustrates an example embodiment for updating a set of entropy values during successive cancellation list decoding based on entropy metrics in accordance with the present disclosure;

FIG. 8 illustrates an example embodiment for discarding decoding paths during successive cancellation list decoding based on entropy metrics in accordance with the present disclosure;

FIG. 9 illustrates an example embodiment for creating a set of list sizes for an information set during successive cancellation list decoding based on entropy metrics in accordance with the present disclosure; and

FIG. 10 comparatively illustrates performance of standard successive cancellation list decoding and successive cancellation list decoding based on entropy metrics in accordance with the present disclosure.

### DETAILED DESCRIPTION

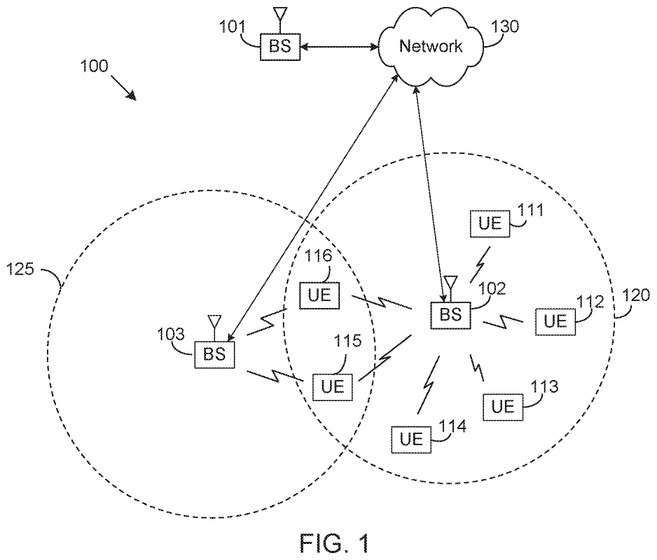

FIGS. 1 through 10, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

The following documents are hereby incorporated by reference into the present disclosure as if fully set forth herein:
[1] E. Arikan, “Channel Polarization: A Method for Constructing Capacity-Achieving Codes for Symmetric Binary-Input Memoryless Channels,” in IEEE Transactions on Information Theory, vol. 55, no. 7, pp. 3051-373 July 2009.
[2] Tal, Ido, and Alexander Vardy. “List decoding of polar codes.” IEEE transactions on information theory 61.5 (2015): 2213-2226.
[3] Balatsoukas-Stimming, Alexios, Mani Bastani Parizi, and Andreas Burg. “LLR-based successive cancellation list decoding of polar codes.” IEEE transactions on signal processing 63.19 (2015): 5165-5179.

Polar codes with cyclic redundancy check (CRC) bits and successive cancellation list (SCL) decoding have shown prominent error-correcting performance at short lengths, and accordingly have been adopted as channel codes by the 5th Generation (5G) New Radio (NR) standard to support the transmission of control information. SCL decoding, leveraging the principles of maximum likelihood (ML) decoding, plays an important role in the success of polar codes.

Polar codes of length N and dimension K can be defined with a generator matrix

$${G}_{N} = {[ \begin{matrix}1 & 0 \\ 1 & 1\end{matrix} ]}^{⊗ n}$$

and an information set [symbol] containing K bit indices selected from {0, 1, 2, . . . , N−1}, where ⊗ is the Kronecker product and N=2ⁿ. Based on the information set [symbol] , K message bits are mapped to a length-N binary vector u=(u₀, u₁, . . . , u_{N-1}) by assigning the K message bits to {uᵢ:i∈ [symbol] } and N−K frozen bits, usually zero bits, to {uᵢ=0:i∈{0, 1, 2, . . . , N−1}\ [symbol] }. Note that the K bits may contain both message bits and CRC bits. Given u=(u₀, u₁, . . . , u_{N-1}), a codeword x which will be transmitted through a channel is generated as x=u×G_{N}. In an example polar code of length 8 and dimension 4 with an information set [symbol] ={3,5,6,7} and four message bits {m₀, m₁, m₂, m₃}, the length-8 binary vector u is obtained as follows:

$$u = \{ 0 , 0 , 0 , {m}_{0} , 0 , {m}_{1} , {m}_{2} , {m}_{3} \} .$$

Then, the codeword x is obtained as follows:

$$\{ 0 , 0 , 0 , {m}_{0} , 0 , {m}_{1} , {m}_{2} , {m}_{3} \} \times [ \begin{matrix}1 & 0 & 0 & 0 & 0 & 0 & 0 & 0 \\ 1 & 1 & 0 & 0 & 0 & 0 & 0 & 0 \\ 1 & 0 & 1 & 0 & 0 & 0 & 0 & 0 \\ 1 & 1 & 1 & 1 & 0 & 0 & 0 & 0 \\ 1 & 0 & 0 & 0 & 1 & 0 & 0 & 0 \\ 1 & 1 & 0 & 0 & 1 & 1 & 0 & 0 \\ 1 & 0 & 1 & 0 & 1 & 0 & 1 & 0 \\ 1 & 1 & 1 & 1 & 1 & 1 & 1 & 1\end{matrix} ] .$$

During SCL decoding, a list of decoding paths is updated. The trade-off between the decoding complexity and the performance of polar codes are impacted by the list size for SCL decoding. A large list size improves the performance but increases the complexity and vice versa.

The disclosed technology optimizes the complexity-performance trade-off by adaptively changing the list size based on an entropy-based metric, such that the complexity of SCL decoding can be reduced while maintaining the error-correcting performance.

Discussion of 5G systems and frequency bands associated therewith is merely for reference, as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems using polar codes designed for successive cancellation list decoding in accordance with the present disclosure. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 for use of polar codes designed for successive cancellation list decoding based on entropy metrics according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for low overhead CSI-RS transmission and CSI feedback. In certain embodiments, one or more of the gNBs 101-103 includes circuitry, programing, or a combination thereof, to support low overhead CSI-RS transmission and CSI feedback in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

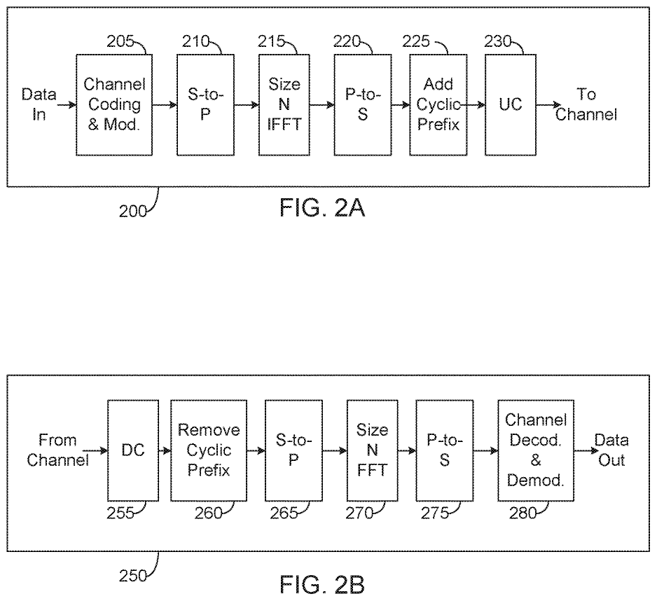

FIGS. 2A and 2B illustrate example wireless transmit and receive paths for use of polar codes designed for successive cancellation list decoding based on entropy metrics according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support low overhead CSI-RS transmission and CSI feedback as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network.

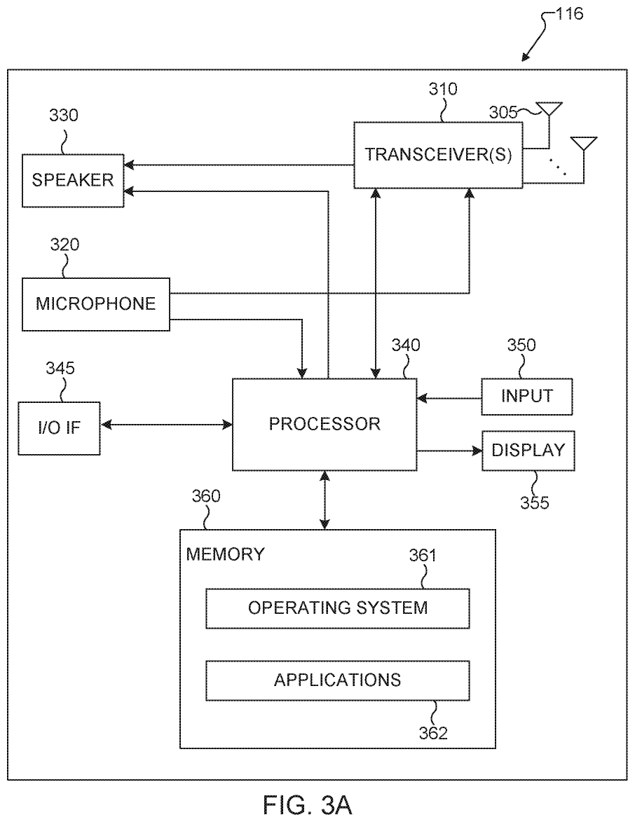

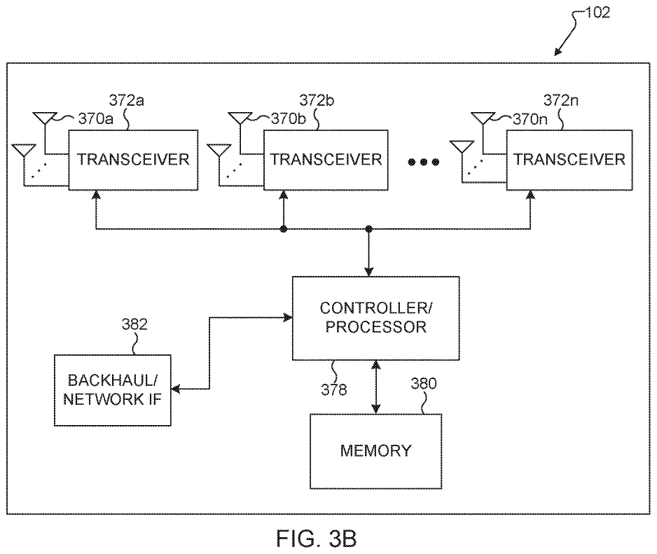

FIG. 3A illustrates an example UE 116 for use of polar codes designed for successive cancellation list decoding based on entropy metrics according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for low overhead CSI-RS transmission and CSI feedback as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 for polar codes designed for successive cancellation list decoding based on entropy metrics according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support low overhead CSI-RS transmission and CSI feedback as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted, and additional components could be added according to particular needs.

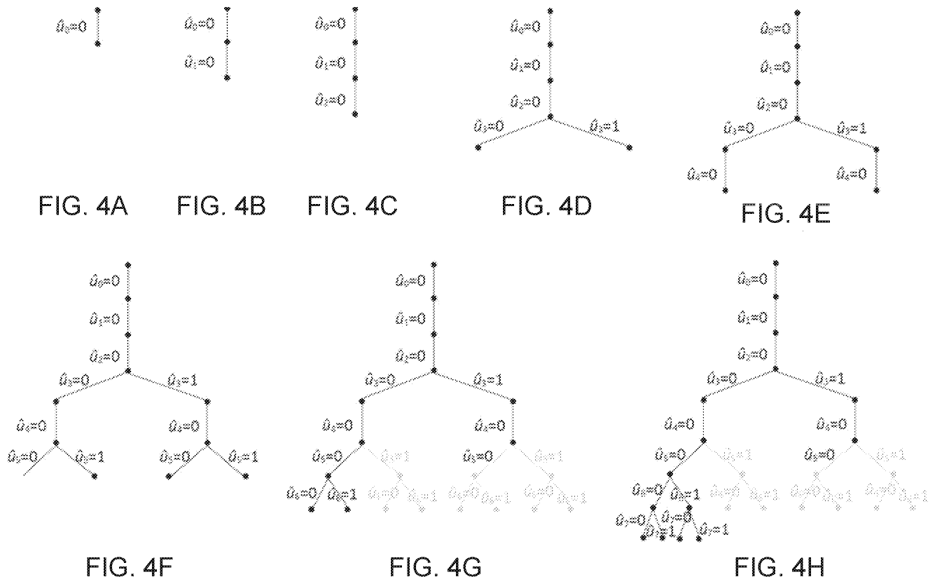

In general, SCL decoding can be considered as a breadth-first search (BFS) algorithm. When recovering information bits, e.g., {û₃, û₅, û₆, û₇} in FIGS. 4A-4H, each path is extended in two directions; otherwise in the direction of the bit is toward zero, only. As decoding progresses, the number of paths grows exponentially. To manage this growth, a threshold, namely the list size L, is set. When the number of paths exceeds L, only the best L paths among the surviving paths are retained and extended, while the remaining paths are pruned. For example, in FIGS. 4A-4H with L=2, when decoding {û₅, û₆, û₇}, where the total number of path exceed 2, the grayed-out paths are pruned. Conventionally, the list size L is set to a fixed value throughout the decoding process. In the present disclosure, however, the list size L is adaptive, based on entropy metrics.

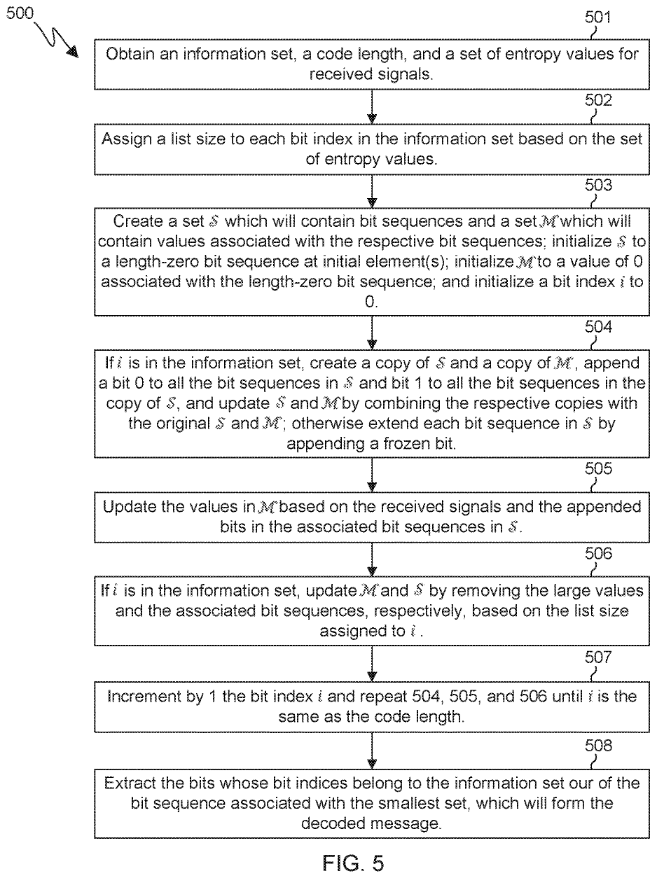

FIGS. 4A through 4H diagrammatically illustrate a polar code designed for successive cancellation list decoding based on entropy metrics in accordance with the present disclosure. FIG. 5 illustrates, for the polar codes of the type in the example of FIGS. 4A through 4H, successive cancellation list decoding based on entropy metrics in accordance with the present disclosure. In both FIGS. 4A-4H and FIG. 5, the bit estimates {û₀, û₁, . . . , û_{N-1}} are recovered in order during SCL decoding, where ûᵢ represents the estimated version of uᵢ. At the stage i of SCL decoding, the bit ûᵢ is recovered, e.g., in FIGS. 4A-4H, the bit estimates {û₀, û₁, . . . , û₇} are recovered at stages 0-7, respectively.

FIGS. 4A through 4H depict an example SCL decoding for a polar code of dimension 4 and length 8 with the information set [symbol] ={3,5,6,7}, in which the information bits {u₀, u₁, . . . , u₇} are recovered via estimates {û₀, û₁, . . . , û₇} at stages 0 through 7. A decoding path is extended towards the direction of ûᵢ=0 when i is not in the information set, e.g., at stages {0,1,2,4} in FIGS. 4A-4H, since the values and the positions of frozen bits are revealed to SCL decoding. When i is in the information set, a decoding path is split into two paths which are then extended toward the directions of ûᵢ=0 and ûᵢ=1, respectively. As a result of the decoding path splitting into two paths, the number of decoding paths grows exponentially. To reduce the complexity of SCL decoding, after each decoding stage, a group of the decoding paths are discarded for future extension, e.g., the grayed-out paths at stages 6 and 7 in FIGS. 4G and 4H.

Accordingly, for the example of FIGS. 4A-4H, estimates û₀=0 of a first bit, û₁=0 of a second bit, and û₂=0 of a third bit are decoded at stages 0, 1, and 2 depicted in FIGS. 4A, 4B, and 4C, respectively. At stage 3 depicted in FIG. 4D, estimates of both û₃=0 and û₃=1 are produced in a split of the decoding path, followed by estimate û₄=0 for both resulting decoding paths at stage 4, depicted in FIG. 4E. Estimates of both û₅=0 and û₅=1 are produced in another split of the decoding path at stage 5, depicted in FIG. 4F. At stage 6 depicted in FIG. 4G, however, decoding paths corresponding to û₃=1 and û₄=0 (including paths corresponding to û₅=0) are discarded. Similarly, decoding paths corresponding to û₃=0, û₄=0, and û₅=1 are also discarded. Still another split of the decoding path occurs at stage 6, producing estimates of both û₆=0 and û₆=1. At stage 7 depicted in FIG. 4H, two splits of the decoding path produce û₇=0 and û₇=1 for û₆=0 and û₇=0 and û₇=1 for û₆=1. Stage 7 corresponds to the length 8 of the polar code, and decoding ends at that point.

As exemplified in FIGS. 4A-4H and FIG. 5, each decoding path in the present disclosure is associated with a value, called a path metric. SCL decoding tends to keep the decoding paths associated with small path metrics. The number of the discarded decoding paths depends on a parameter, called the list size. After the last stage, e.g., the stage 7 in FIGS. 4A-4H, one of the surviving decoding paths will be selected as the decoded message.

A transition probability p(y|x) is used to characterize a channel with the transmitted codeword x={x₀, x₁, . . . , x_{N-1}} and the received signals y={y₀, y₁, . . . , y_{N-1}}. At the stage i of SCL decoding, a value, denoted λᵢ, can be calculated based on the transition probabilities {p(yᵢ|xᵢ):i∈{0, 1, 2, . . . , N−1}} and the bits recovered in previous stages, i.e., {û₀, û₁, . . . , ûᵢ₋₁}. λᵢ can be a log likelihood ratio which is defined as the logarithm of the probability of ûᵢ=0 divided by the probability of ûᵢ=1. λᵢ will be used to update the path metrics.

Accordingly, referring to FIG. 5, at step 501 an information set [symbol] , a code length N, and a set of entropy values, denoted [symbol] ≙{H₀, H₁, . . . , H_{N-1}}, are obtained for the received signals y={y₀, y₁, . . . , y_{N-1}}. One embodiment for generating [symbol] is according to density evolution via Gaussian approximation (DEGA). An example set of entropy values for N=128 obtained by performing DEGA at SNR=−1 decibels (dB) is given by:

$$\text{?} = \{ 0.989477098 , 0.979105592 , 0.989301503 , 0.958776474 , 0.989476919 , 0.978496671 , 0.987506032 , 0.906632841 , 0.989477158 , 0.978897572 , 0.988489449 , 0.928779364 , 0.988250852 , 0.922686934 , 0.894814968 , 0.491336972 , 0.9894768 , 0.978364408 , 0.987209916 , 0.901084185 , 0.985698521 , 0.877082467 , 0.828258097 , 0.372704595 , 0.977829874 , 0.796892762 , 0.72184509 , 0.247750968 , 0.60550034 , 0.157196507 , 0.105266161 , 0.003830004 , 0.989467621 , 0.974599481 , 0.979857922 , 0.81372565 , 0.970582962 , 0.747232854 , 0.660923779 , 0.19597429 , 0.941054165 , 0.616412342 , 0.513929963 , 0.106330067 , 0.392344475 , 0.05800467 , 0.035091288 , 0.000453188 , 0.868485928 , 0.438647658 , 0.338314533 , 0.042106483 , 0.239485264 , 0.020360056 , 0. 0115162240 , 5.1913 e - 05 , 0.156704962 , 0.00854118300 , 0.00450785000 , 8.355 \; 45000 e - 06 , 0.00244941800 , 2.52435000 e - 06 , 1.17238000 e - 06 , 1.148380 \; 00 e - 26 , 0.98919 , 0.952827215 , 0.942419171 , 0.621131539 , 0.901980698 , 0.507468045 , 0.403428853 , 0.061655201 , 0.81762886 , 0.357472152 , 0.265752256 , 0.025282737 , 0.184899136 , 0.0119601880 , 0.00638109400 , 1.644 \; 58000 e - 05 , 0.682418168 , 0.213018 , 0.14735359 , 0.007540122 , 0.094878808 , 0.003012352 , 0.00163953500 , 9.51 \; 222000 e - 07 , 0.0550001520 , 0.00103451100 , 0.000557296000 , 4.928020 \; 00 e - 09 , 0.000297494000 , 1.20674000 e - 10 , 1.5 \; 0407000 e - 11 , 0 , 0.51654309 \text{.0} \text{.107588731} , 0.070534773 , 0.001679717 , 0.040410973 , 0. 000596227000 , 0.000319766000 , 1.872220 \; 00 e - 10 , 0.0216086170 , 0.000176574000 , 9.39378000 e - 05 , 7.875980 \; 00 e - 14 , 4.96598000 e - 05 , 1.16694000 e - 15 , 1.205340 \; 00 e - 16 , 0 , 0.0118241830 , 5.46486000 e - 05 , 2.88982000 e - 05 , 3.016980 \; 00 e - 17 , 1.52033000 e - 05 , 3.6599 e - 19 , 3.48216000 e - 20 , 0 , 7.964 \; 87000 e - 06 , 4.02443000 e - 21 , 3.69755000 e - 22 , 0 , 3.3353 e - 23 , 0 , 7.493250 \; 00 e - 26 , 0 \} .$$

A table of [symbol] for multiple values of N can be specified for multiple SNRs through signaling between transmitter and receiver.

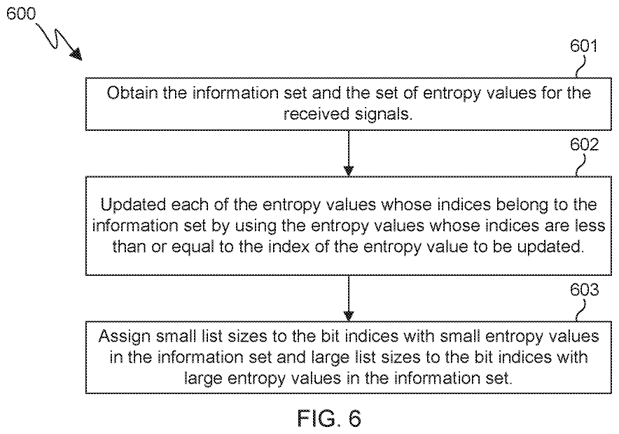

At step 502 of FIG. 5, the set [symbol] of entropy values are employed to assign a list size to each bit index i in the information set [symbol] . One embodiment for assigning a list size to each bit index in the information set is according to the process described below in connection with FIG. 6. Let lᵢ denote the list size assigned to the bit index i∈ [symbol] . The number of the decoding paths that are kept after the stage i∈ [symbol] is equal to the list size lᵢ.

As noted above, each decoding path, representing a bit sequence, is associated with a value, called path metric. A path metric represents the penalty applied to the associated decoding path. The decoding paths towards the correct directions tend to have small path metrics and are kept for future extension.

Therefore, at step 503 in FIG. 5, a set S which will contain bit sequences and a set [symbol] which will contain values of path metrics associated with the respective bit sequences are created. The set [symbol] is initialized to a length-zero bit sequence as its initial element, and the set [symbol] is initialized to a value of 0 associated with the length-zero bit sequence, i.e., [symbol] ←{{ }} and [symbol] ←{0}. Since SCL decoding decodes from u₀ to u_{N-1} in sequence, the bit index i is initialized to 0.

At step 504 in FIG. 5, if the bit index i is not in the information set [symbol] , all the bit sequences in the set [symbol] are updated by appending a frozen bit. If the bit index i is in the information set [symbol] , a copy of the set [symbol] and a copy of the set [symbol] are created and denoted as [symbol] ′ and [symbol] ′, respectively. All bit sequences in one of the two sets [symbol] and [symbol] ′ are extended by appending a bit 0, while all the bit sequences in the other set are extended by appending a bit 1. For example, all the bit sequences in [symbol] are extended by appending a bit 0 while all the bit sequences in [symbol] ′ are extended by appending a bit 1. Then, the set [symbol] and the set [symbol] are updated by including all the members in the respective copies, i.e., [symbol] ← [symbol] ∪ [symbol] ′ and [symbol] ← [symbol] ∪ [symbol] ′.

At step 505 in FIG. 5, each path metric in the set [symbol] can be updated based on the bit appended to the end of the associated bit sequence in the set [symbol] , i.e., ûᵢ, and the LLR λᵢ calculated based on the transition probabilities {p(yᵢ|xᵢ):i∈{0, 1, 2, . . . , N−1}} and the bits recovered in previous stages, i.e., {û₀, û₁, . . . , ûᵢ₋₁}. Let m denote a path metric in the set M and u denote the bit appended to the end of the associated bit sequence. An example update of m is shown as follows:

$$m ← \{ \begin{matrix}m , & if {\hat{u}}_{i} = 0.5 ( 1 - sign ( {λ}_{i} ) ) \\ m + \vert {λ}_{i} \vert , & otherwise\end{matrix}$$

where sign(λᵢ)=−1 if λᵢ<0, otherwise sign(λᵢ)=1. In other words, at the stage i, if the sign of the LLR λᵢ does not comply with the value of ûᵢ in a decoding path, the magnitude of λᵢ will be added to the associated path metric as a penalty.

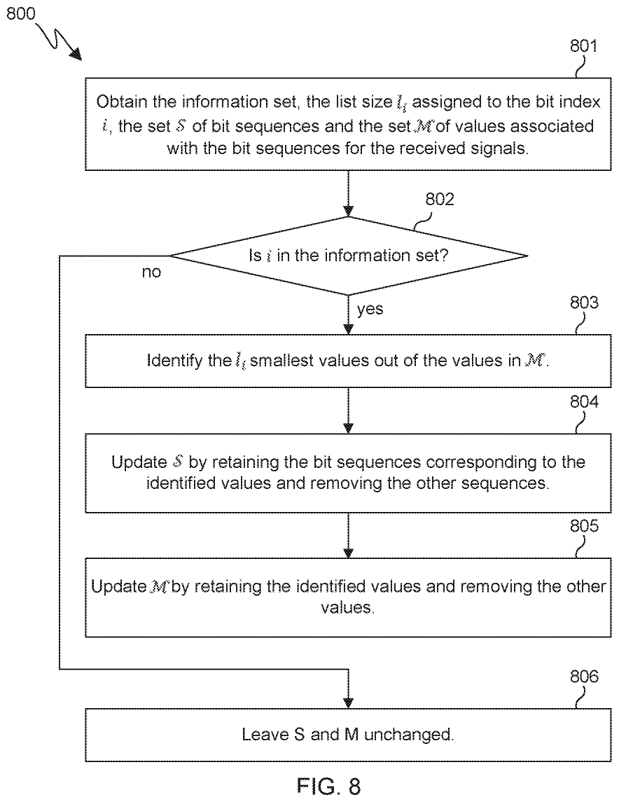

At step 506 in FIG. 5, if the bit index i is in the information set, the set [symbol] is updated by maintaining the lᵢ smallest path metrics and discarding the other path metrics. In correspondence, the set [symbol] is updated by maintaining the bit sequences associated with the maintained path metrics and discarding the other bit sequences. One embodiment for updating [symbol] and [symbol] based on the list size lᵢ is described below in connection with FIG. 8.

At step 507 in FIG. 5, the bit index i is increased by 1, i.e., i←i+1, and then steps 504, 505, and 506 are repeated until the value of the bit index i is same as the code length N.

At step 508 in FIG. 5, let

$${\hat{u}}^{*} = \{ {\hat{u}}_{0}^{*} , {\hat{u}}_{1}^{*} , ⋯ , {\hat{u}}_{N - 1}^{*} \}$$

denote the bit sequence out of the bit sequences in [symbol] whose associated path metric in [symbol] is the smallest. Then, the message is obtained as the bits in û* whose bit indices belong to the information set, i.e.,

$$\{ {\hat{u}}_{i}^{*} : i ∈ \text{?} \} .$$

As previously noted, FIGS. 4A through 4H illustrate an example of the process 500 in FIG. 5, by which a polar code of length 8 and dimension 4 is decoded by using SCL decoding. Referring step 501 in FIG. 5, [symbol] ={3,5,6,7} and N=8 are obtained.

Referring to step 502 in FIG. 5, the list sizes assigned to the bit indices in the information set [symbol] ={3,5,6,7} are given by l₃=2, l₅=4, l₆=2 and l₇=4.

Referring to step 503 in FIG. 5, the sets S and M are created and initialized to {{ }} and {0}, respectively. In addition, the bit index i is initialized to 0.

Referring to FIG. 4A (stage 0) and step 504 in FIG. 5, because the bit index i=0 is not in the information set [symbol] , the set [symbol] is updated by appending a bit 0 to all the sequences in the set, i.e., [symbol] ←{{0}} and the set [symbol] is unchanged. Referring to step 505 in FIG. 5, given λ₀=0.01, the bit metric 0 in the set [symbol] for the bit sequence {0} is updated to 0. Referring to step 506, because the bit index 0 is not in the information set [symbol] , no operations are applied to the sets [symbol] and [symbol] . Referring to step 507, the process goes to step 504.

Referring to FIG. 4B (stage 1) and step 504 in FIG. 5, because the bit index i=1 is not in the information set [symbol] , the set [symbol] is updated by appending a bit 0 to all the sequences in the set, i.e., [symbol] ←{{0,0}} and the set [symbol] is unchanged. Referring to step 505, given λ₁=0.1, the bit metric 0 in the ste [symbol] for the bit sequence {0,0} is updated to 0. Referring to step 506, because the bit index i=1 is not in the information set [symbol] , no operations are applied to the sets [symbol] and [symbol] . Referring to step 507, the process goes to step 504.

Referring to FIG. 4C (stage 2) and step 504 in FIG. 5, because the bit index i=2 is not in the information set [symbol] , the set [symbol] is updated by appending a bit 0 to all the sequences in the set, i.e., [symbol] ←{{0,0,0}} and the set [symbol] is unchanged. Referring to step 505, given λ₂=0.02, the bit metric 0 in [symbol] for the bit sequence {0,0,0} is updated to 0. Referring to step 506, because the bit index i=2 is not in the information set [symbol] , no operations are applied to the sets S and M. Referring to step 507, the process returns to step 504.

Referring to FIG. 4D (stage 3) and step 504 in FIG. 5, because the bit index i=3 is in the information set [symbol] , the copies of [symbol] ={0,0,0} and [symbol] ={0} are created and denoted as [symbol] ′ and [symbol] ′, respectively. By appending a bit 0 and 1 to all the sequences in the sets [symbol] and [symbol] ′, respectively, and then including all the members in the sets [symbol] ′ into [symbol] , the set [symbol] is updated to {{0,0,0,0}, {0,0,0,1}}. Correspondingly, the set [symbol] is updated to {0,0} by including the members in its copy [symbol] ′. Referring to step 505, given λ₃=0.1, the bit metric 0 in the set [symbol] for the bit sequence {0,0,0,0} is updated to 0 and the bit metric 0 in the set [symbol] for the bit sequence {0,0,0,1} is updated to 0.1 i.e., [symbol] ←{0,0.1}. Referring to step 506, because the bit index i=3 is in the information set [symbol] and list size l₃=2, all the bit sequences in the set [symbol] and the associated metrics in the set [symbol] are kept for the next iteration. Referring to step 507, the process goes to step 504.

Referring to FIG. 4E (stage 4) and step 504 in FIG. 5, because the bit index i=4 is not in the information set [symbol] , the set [symbol] is updated by appending a bit 0 to all the sequences in the set, i.e., [symbol] ←{{0,0,0,0,0}, {0,0,0,1,0}} and the set [symbol] ={0,0.1} is unchanged. Referring to step 505, given λ₄=−0.05, the bit metric 0 in the set [symbol] for the bit sequence {0,0,0,0,0} is updated to 0.05 and the bit metric 0.1 in the set [symbol] for the bit sequence {0,0,0,1,0} is updated to 0.15, i.e., [symbol] ←{0.05,0.15}. Referring to step 506, because the bit index i=4 is not in the information set [symbol] , no operations are applied to the sets [symbol] and [symbol] . Referring to step 507, the process goes to step 504.

Referring to FIG. 4F (stage 5) and step 504 in FIG. 5, because the bit index i=5 is in the information set [symbol] , the copies of the set [symbol] ={0,0,0,0,0}, {0,0,0,1,0} and the set [symbol] ={0005,0.15} are created and denoted as [symbol] ′ and [symbol] ′, respectively. By appending a bit 0 and 1 to all the sequences in the set [symbol] and the set [symbol] ′, respectively, and then including all the members in [symbol] ′ into [symbol] , the set [symbol] is updated to {{0,0,0,0,0,0}, {0,0,0,1,0,0}, {0,0,0,0,0,1}, {0,0,0,1,0,1}}. Correspondingly, the set [symbol] is updated to {0.05,0.15,0.05,0.15} by including the members in its copy [symbol] ′. Referring to step 505, given λ₅=0.2, the bit metrics [symbol] ={0.05,0.15,0.05,0.15} for the bit sequences [symbol] ={0,0,0,0,0,0}, {0,0,0,1,0,0}, {0,0,0,0,0,1}, {0,0,0,1,0,1} are updated to [symbol] ={0.05,0.15,0.25,0.35}. Referring to step 506, because the bit index i=5 is in the information set [symbol] and the list size l₅=4, all the bit sequences in the set [symbol] and the associated metrics in the set [symbol] are kept for the next iteration. Referring to step 507, the process goes to step 504.

Referring to FIG. 4G (stage 6) and step 504 in FIG. 5, because the bit index i=6 is in the information set [symbol] , the copies of the set [symbol] ={{0,0,0,0,0,0}, {0,0,0,1,0,0}, {0,0,0,0,0,1}, {0,0,0,1,0,1}} and the set [symbol] ={0.05,0.15,0.25,0.35} are created and denoted as [symbol] ′ and [symbol] ′, respectively. By appending a bit 0 and 1 to all the sequences in the set [symbol] and the set [symbol] ′, respectively, and then including all the members in the set [symbol] ′ into the set [symbol] , the set [symbol] is updated to

$$\{ \begin{matrix}\{ 0 , 0 , 0 , 0 , 0 , 0 , 0 \} , \{ 0 , 0 , 0 , 1 , 0 , 0 , 0 \} , \\ \{ 0 , 0 , 0 , 0 , 0 , 1 , 0 \} , \{ 0 , 0 , 0 , 1 , 0 , 1 , 0 \} , \\ \{ 0 , 0 , 0 , 0 , 0 , 0 , 1 \} , \{ 0 , 0 , 0 , 1 , 0 , 0 , 1 \} , \\ \{ 0 , 0 , 0 , 0 , 0 , 1 , 1 \} , \{ 0 , 0 , 0 , 1 , 0 , 1 , 1 \}\end{matrix} \} .$$

Correspondingly, the set [symbol] is updated to

$$\{ \begin{matrix}0.05 , 0.15 , 0.25 , 0.35 , \\ 0.05 , 0.15 , 0.25 , 0.35\end{matrix} \}$$

by including the members in its copy [symbol] ′. Referring to step 505, given λ₆=−0.05, the bit metric

$$\text{?} = \{ \begin{matrix}0.05 , 0.15 , 0.25 , 0.35 , \\ 0.05 , 0.15 , 0.25 , 0.35\end{matrix} \}$$

for the bit sequences

$$\text{?} = \{ \begin{matrix}\{ 0 , 0 , 0 , 0 , 0 , 0 , 0 \} , \{ 0 , 0 , 0 , 1 , 0 , 0 , 0 \} , \\ \{ 0 , 0 , 0 , 0 , 0 , 1 , 0 \} , \{ 0 , 0 , 0 , 1 , 0 , 1 , 0 \} , \\ \{ 0 , 0 , 0 , 0 , 0 , 0 , 1 \} , \{ 0 , 0 , 0 , 1 , 0 , 0 , 1 \} , \\ \{ 0 , 0 , 0 , 0 , 0 , 1 , 1 \} , \{ 0 , 0 , 0 , 1 , 0 , 1 , 1 \}\end{matrix} \}$$

are updated to

$$\text{?} = \{ \begin{matrix}0.1 , 0.2 , 0.3 , 0.4 , \\ 0 \text{.05} , 0.15 , 0.25 , 0.35\end{matrix} \} .$$

Referring to step 506, because the bit index i=6 is in the information set and the list size l₆=2, the six bit sequences (shown in strikethrough)

$$\{ \begin{matrix}\{ 0 , 0 , 0 , 0 , 0 , 0 , 0 \} , \text{?} \\ \{ 0 , 0 , 0 , 0 , 0 , 0 , 1 \} , \text{?}\end{matrix} \}$$

and the path metrics (also shown in strikethrough)

$$\{ \begin{matrix}0.1 , \text{?} , \\ 0.05 , \text{?}\end{matrix} \}$$

are removed from the respective sets. The remaining bit sequences and path metrics, i.e., [symbol] ={0,0,0,0,0,0,0}, {0,0,0,0,0,0,1} and [symbol] ={0.1,0.05}, are kept for the next iteration. Referring to step 507, the process goes to step 504.

Referring to FIG. 4H (stage 7) and step 504 in FIG. 5, because the bit index i=7 is in the information set [symbol] , the copies of the set [symbol] ={0,0,0,0,0,0,0}, {0,0,0,0,0,0,1} and the set [symbol] ={0.1,0.05} are created and denoted as [symbol] ′ and [symbol] ′, respectively. By appending a bit 0 and 1 to all the sequences in [symbol] and [symbol] ′, respectively, and then including all the members in [symbol] ′ into [symbol] , the set [symbol] is updated to {{0,0,0,0,0,0,0,0}, {0,0,0,0,0,0,1,0}, {0,0,0,0,0,0,0,1}, {0,0,0,0,0,0,1,1}}. Correspondingly, the set [symbol] is updated to {0.1,0.05,0.1,0.05} by including the members in its copy [symbol] ′. Referring to 505, given λ₇=0.1, the bit metrics [symbol] ={0.1,0.05,0.1,0.05} for the bit sequences [symbol] ={0,0,0,0,0,0,0,0}, {0,0,0,0,0,0,1,0}, {0,0,0,0,0,0,0,1}, {0,0,0,0,0,0,1,1} are updated to [symbol] ={0.1,0.05,0.2,0.15}. Referring to step 506, because the bit index i=7 is in the information set [symbol] and the list size l₄=4, all four bit sequences in [symbol] ={{0,0,0,0,0,0,0,0}, {0,0,0,0,0,0,1,0}, {0,0,0,0,0,0,0,1}, {0,0,0,0,0,0,1,1}} and the associated path metrics [symbol] ={0.1,0.05,0.2,0.15} are kept. Referring to step 507, the process goes to step 508.

Referring to step 508 in FIG. 5, the decoded message for the example of FIGS. 4A-4H will be extracted from the second sequence û*={0,0,0,0,0,0,1,0} in the [symbol] because its associated path metric 0.05 is the smallest. According to the information set [symbol] , the bits at indices {3,5,6,7} are extracted from û* to form the decoded message {0,0,1,0}.

FIG. 6 illustrates an example embodiment for creating a set of list sizes for an information set used with successive cancellation list decoding based on entropy metrics in accordance with the present disclosure.

FIG. 6 illustrates an example embodiment corresponding to step 502 in FIG. 5, to assign a list size lᵢ to a bit index i in the information set [symbol] .

At step 601, the information set [symbol] and the set [symbol] ={H₀, H₁, . . . , H_{N-1}} of entropy values are obtained for a polar code of length N and dimension K.

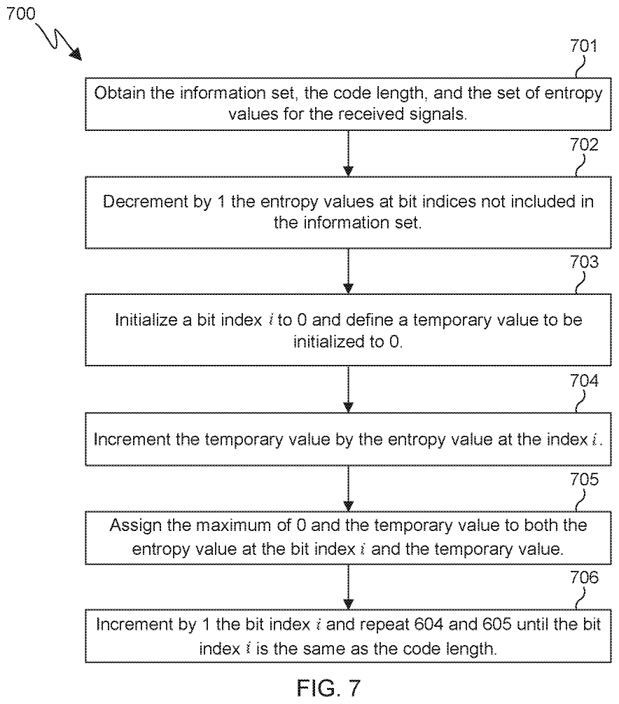

At step 602, each entropy value in the set [symbol] whose bit index belongs to the information set is updated by using the entropy values in the set [symbol] whose bit indices are less than or equal to the index of the entropy value to be updated. One embodiment for updating the set [symbol] of entropy values is described below in connection with FIG. 7.

At step 603, the list size assigned to the bit index i ∈ [symbol] is according to the value of Hᵢ. Small list sizes will be assigned to the bit indices with small entropy values in the information set, and large list sizes will be assigned to the bit indices with large entropy values in the information set. The bit indices in the information set are divided into g groups, denoted as { [symbol] ₁, [symbol] ₂, . . . , [symbol] _{g}}, with

$$\text{?} {H}_{i} < \text{?} {H}_{i} ,$$

where j∈{1, 2, . . . , g−1}. There is a group of list sizes {L₁, L₂, . . . , L_{g}} which can be specified and have the relationship L₁<L₂< . . . <L_{g}. Then, Lⱼ is assigned to the bit indices in [symbol] ⱼ, i.e., lᵢ=Lⱼ for i∈ [symbol] ⱼ, where j∈{1, 2, . . . , g}. For example, when H₃<H₆<H₅<H₇ for a polar code with information set [symbol] ={3,5,6,7}, L₁=2 can be assigned to the bit indices [symbol] ₁={3,6} due to their relatively smaller values and L₂=4 can be assigned to the bit indices [symbol] ₂={5,7} due to their relatively larger values.

FIG. 7 illustrates an example embodiment for updating a set of entropy values during successive cancellation list decoding based on entropy metrics in accordance with the present disclosure.

FIG. 7 illustrates an example embodiment corresponding to step 602 in FIG. 6, to update the set [symbol] of entropy values according to the information set.

At step 701, the information set [symbol] and the set [symbol] ={h₀, h₁, . . . , h_{N-1}} of entropy values are obtained for a polar code of length N and dimension K.

At step 702, the set of entropy values are updated by subtracting 1 from the entropy values whose bit indices do not belong to the information set, i.e., Hᵢ←Hᵢ−1 for i∈{0, 1, . . . , N−1}\ [symbol] . The entropy values at the bit indices belonging to the information set [symbol] are unchanged.

At step 703, a temporary value, denoted d, is initialized to 0 to store the accumulated entropy values. The accumulation procedure starts from the first entropy value, and hence the bit index i is initialized to 0.

At step 704, the temporary value d is incremented by adding the entropy value at the index i, i.e., d←d+Hᵢ.

At step 705, if the temporary value d is less than 0, both the entropy value at the bit index i and the temporary value are set to 0; otherwise both are set to the temporary value, i.e., d=Hᵢ←max{0, d}.

At step 706, if the bit index i is smaller than the code length N, the bit index i is incremented by 1 for the next iteration of steps 704 and 705.

Hence, Hᵢ can be updated from the bit index 0 to the bit index N−1 recursively by iteratively applying steps 704 and 705.

FIG. 8 illustrates an example embodiment for discarding decoding paths during successive cancellation list decoding based on entropy metrics in accordance with the present disclosure.

FIG. 8 illustrates an example embodiment corresponding to step 506 in FIG. 5, to update the set [symbol] of bit sequences and the set [symbol] of path metrics associated with the bit sequences.

At step 801, the information set [symbol] , the list size lᵢ assigned to the bit index i∈ [symbol] , the set [symbol] of bit sequences and the set [symbol] of path metrics are obtained.

At step 802, [symbol] and [symbol] are updated using steps 803 through 805 if the bit index i is in the information set; otherwise remain unchanged (step 806).

At step 803, the lᵢ smallest path metrics out of the path metrics in [symbol] are identified. Note that if the list size lᵢ is larger than or equal to the size of [symbol] , all the path metrics metrics in [symbol] will be identified.

At step 804, [symbol] is updated by retaining the bit sequences associated with the identified path metrics and removing the other sequences.

At step 805, [symbol] is updated by retaining the identified path metrics and removing the other path metrics.

For example, referring 801, the information set [symbol] ={3,5,6,7}, the bit index i=6, the corresponding list size l₆=2, the set of the bit sequences

$$\text{?} = \{ \begin{matrix}\{ 0 , 0 , 0 , 0 , 0 , 0 , 0 \} , \{ 0 , 0 , 0 , 1 , 0 , 0 , 0 \} , \{ 0 , 0 , 0 , 0 , 0 , 1 , 0 \} , \{ 0 , 0 , 0 , 1 , 0 , 1 , 0 \} , \\ \{ 0 , 0 , 0 , 0 , 0 , 0 , 1 \} , \{ 0 , 0 , 0 , 1 , 0 , 0 , 1 \} , \{ 0 , 0 , 0 , 0 , 0 , 1 , 1 \} , \{ 0 , 0 , 0 , 1 , 0 , 1 , 1 \}\end{matrix} \}$$

and the set of the associated path metrics

$$\text{?} = \{ \begin{matrix}0.1 , 0.2 , 0.3 , 0.4 , \\ 0.05 , 0.15 , 0.25 , 0.35\end{matrix} \}$$

are obtained.

Referring to step 802, because the bit index 6 belongs to the information set {3,5,6,7}, the process goes to step 803.

Referring to step 803, the two path metrics with the relatively smaller values are identified and included in the grey-shaded values:

$$\{ \begin{matrix}0.1 , 0.2 , 0.3 , 0.4 , \\ 0.05 , 0.15 , 0.25 , 0.35\end{matrix} \} .$$

Referring to step 804, the two bit sequences associated with the identified path metrics are included in the dashed box:

$$\{ \begin{matrix}\{ 0 , 0 , 0 , 0 , 0 , 0 , 0 \} , \{ 0 , 0 , 0 , 1 , 0 , 0 , 0 \} , \{ 0 , 0 , 0 , 0 , 0 , 1 , 0 \} , \{ 0 , 0 , 0 , 1 , 0 , 1 , 0 \} , \\ \{ 0 , 0 , 0 , 0 , 0 , 0 , 1 \} , \{ 0 , 0 , 0 , 1 , 0 , 0 , 1 \} , \{ 0 , 0 , 0 , 0 , 0 , 1 , 1 \} , \{ 0 , 0 , 0 , 1 , 0 , 1 , 1 \}\end{matrix} \} .$$

Then, by keeping these two bit sequences and removing the other 6 bit sequences, [symbol] becomes

$$\{ \begin{matrix}\{ 0 , 0 , 0 , 0 , 0 , 0 , 0 \} , \\ \{ 0 , 0 , 0 , 0 , 0 , 0 , 1 \}\end{matrix} \} .$$

Referring to step 805, by keeping these two path metrics and removing the other 6 path metrics, [symbol] becomes

$$\{ \begin{matrix}0.1 , \\ 0.05\end{matrix} \} .$$

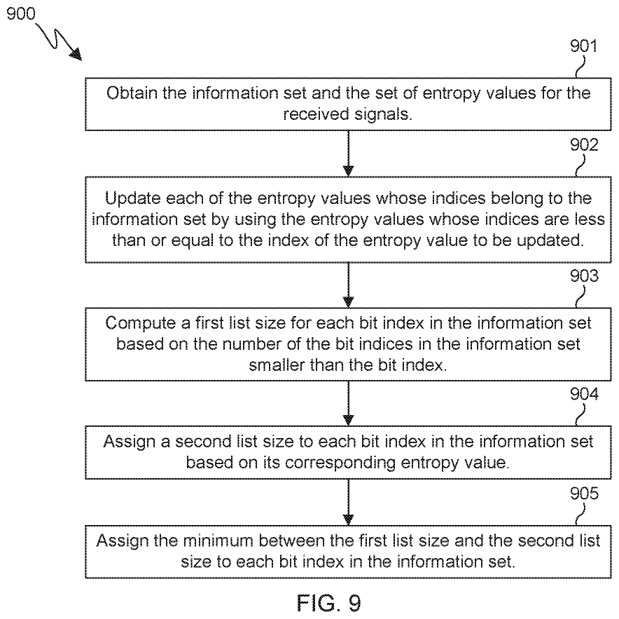

FIG. 9 illustrates an example embodiment for creating a set of list sizes for an information set during successive cancellation list decoding based on entropy metrics in accordance with the present disclosure.

FIG. 9 describes another example embodiment corresponding to step 502 in FIG. 5, to assign a list size lᵢ to a bit index i in the information set [symbol] .

At step 901, the information set [symbol] and the set [symbol] ={H₀, H₁, . . . , H_{N-1}} of entropy values are obtained for a polar code of length N and dimension K.

At step 902, each entropy value in the set [symbol] whose bit index belongs to the information set is updated by using the entropy values in the set [symbol] whose bit indices are less than or equal to the index of the entropy value to be updated. One embodiment for updating the set [symbol] of entropy values is described above in connection with FIG. 7.

At step 903, a first list size

$${l}_{i}^{′}$$

for the bit index i∈ [symbol] is computed based on the number of the bit indices in the information set smaller than the bit index i. Let [symbol] ᵢ denote the set of the bit indices in the information set smaller than or equal to i, i.e., [symbol] ᵢ={j∈ [symbol] :j≤i}. Then, the first list size

$${l}_{i}^{′}$$

is equal to [symbol] .

At step 904, the second list size

$${l}_{i}^{″}$$

assigned to the bit index i∈ [symbol] is according to the value of Hᵢ. Small list sizes will be assigned to the bit indices with small entropy values in the information set, and large list sizes will be assigned to the bit indices with large entropy values in the information set. The bit indices in the information set are divided into g groups, denoted as { [symbol] ₁, [symbol] ₂, . . . , [symbol] _{g}}, with

$$\text{?} {H}_{i} < \text{?} {H}_{i} ,$$

where j∈{1, 2, . . . , g−1}. There is a group of list sizes {L₁, L₂, . . . , L_{g}} which can be specified and have the relationship L₁<L₂< . . . <L_{g}. Then, Lⱼ is assigned to the bit indices in [symbol] ⱼ, i.e.,

$${l}_{i}^{″} = {L}_{j}$$

for i∈ [symbol] ⱼ, where j∈{1, 2, . . . , g}.

At step 905, the minimum between the first list size

$${l}_{i}^{′}$$

and the second list size

$${l}_{i}^{″}$$

is assigned to the bit index i in the information set, i.e.,

$${l}_{i} = min ( {l}_{i}^{′} , {l}_{i}^{″} ) .$$

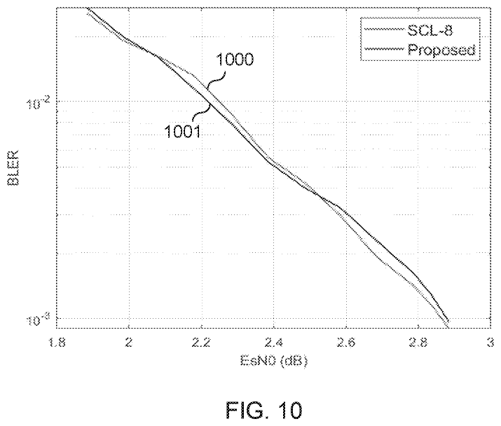

FIG. 10 comparatively illustrates performance of standard successive cancellation list decoding and successive cancellation list decoding based on entropy metrics in accordance with the present disclosure. BLER is plotted as a function of energy per bit to noise power spectral density signal-to-noise ratio (EsN0), measured in dB. For both traces 1000, 1001, N=142, K=60, an 11-bit CRC is employed, and the rate matching and construction of the information set follow 5G NR standards for polar codes. For standard SCL decoding (“SCL-8”) 1000, list size is fixed as L=8. For SCL decoding based on entropy metrics in accordance with the present disclosure (“Proposed”) 1001, the list size 4 is assigned to two bit indices in the formation set with the smallest entropy values and the list size 8 is assigned to the other bit indices in the information set. Trace 1001 reflects performance comparable to trace 1001 while the associated decoding has lower complexity due to smaller list sizes applied to two bit indices.

The disclosed technology can be used to improve the decoding throughput of 5G NR and future cellular polar codes.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claim scope. The scope of patented subject matter is defined by the claims.

What is claimed is:

1. A method comprising:
receiving an information set, a code length, and a set of entropy values for received signals;
adaptively changing a list size based on an entropy-based metric for reducing a computational complexity of successive cancellation list (SCL) decoding and for maintaining error-correcting performance;
determining, for a polar code using the set of entropy values, a respective entropy-based metric for each index in the information set; and
assigning a list size smaller than a specified list size to one or more indices that have entropy-based metrics less than a specified entropy-based metric amount to produce a dynamic list size allocation.

2. The method of claim 1, wherein the error-correcting performance is measured based on simulating a block error rate (BLER) across a range of signal to noise ratios (SNRs).

3. The method of claim 1, wherein maintaining the error-correcting performance is based on a signal-to-noise ratio (SNR) gap being within 0.05 decibels (dB).

4. The method of claim 1, further comprising:
determining a number of retained decoding paths for each remaining index in the information set, excluding the one or more indices that have entropy-based metrics less than the specified entropy-based metric amount; and
assigning a list size to one or more of the remaining indices based on corresponding entropy-based metrics and a corresponding number of the retained decoding paths.

5. The method of claim 1, wherein the set of entropy values for the received signals are generated according to density evolution via Gaussian approximation and stored in a lookup table.

6. The method of claim 1, further comprising:
identifying bit sequences for the received signals for which entropy-based metrics values are smallest; and
retaining the identified bit sequences and removing other bit sequences for the received signals.

7. The method of claim 1, further comprising:
assigning a list size greater than or equal to the specified list size to indices other than the one or more indices that have entropy-based metrics greater than or equal to the specified entropy-based metric amount.

8. A user equipment (UE) comprising:
a transceiver configured to receive an information set, a code length, and a set of entropy values for received signals;
at least one processing device coupled to the transceiver and configured to
adaptively change a list size based on an entropy-based metric for reducing a computational complexity of successive cancellation list (SCL) decoding and for maintaining error-correcting performance,
determine, for a polar code using the set of entropy values, a respective entropy-based metric for each index in the information set, and
assign a list size smaller than a specified list size to one or more indices that have entropy-based metrics less than a specified entropy-based metric amount to produce a dynamic list size allocation.

9. The UE of claim 8, wherein the error-correcting performance is measured based on simulating a block error rate (BLER) across a range of signal to noise ratios (SNRs).

10. The UE of claim 8, wherein maintaining the error-correcting performance is based on a signal-to-noise ratio (SNR) gap being within 0.05 decibels (dB).

11. The UE of claim 8, wherein the at least one processing device is configured to:
determine a number of retained decoding paths for each remaining index in the information set, excluding the one or more indices that have entropy-based metrics less than the specified entropy-based metric amount, and
assign a list size to one or more of the remaining indices based on corresponding entropy-based metrics and a corresponding number of the retained decoding paths.

12. The UE of claim 8, wherein the set of entropy values for the received signals are generated according to density evolution via Gaussian approximation and stored in a lookup table.

13. The UE of claim 8, wherein the at least one processing device is configured to:
identify bit sequences for the received signals for which entropy-based metrics values are smallest, and
retain the identified bit sequences and removing other bit sequences for the received signals.

14. The UE of claim 8, wherein the at least one processing device is configured to:
assign a list size greater than or equal to the specified list size to indices other than the one or more indices that have entropy-based metrics greater than or equal to the specified entropy-based metric amount.

15. A base station (BS) comprising:
a transceiver configured to receive an information set, a code length, and a set of entropy values for received signals;
at least one processing device coupled to the transceiver and configured to
adaptively change a list size based on an entropy-based metric for reducing a computational complexity of successive cancellation list (SCL) decoding and for maintaining error-correcting performance,
determine, for a polar code using the set of entropy values, a respective entropy-based metric for each index in the information set, and
assign a list size smaller than a specified list size to one or more indices that have entropy-based metrics less than a specified entropy-based metric amount to produce a dynamic list size allocation.

16. The BS of claim 15, wherein the error-correcting performance is measured based on simulating a block error rate (BLER) across a range of signal to noise ratios (SNRs).

17. The BS of claim 15, wherein maintaining the error-correcting performance is based on a signal-to-noise ratio (SNR) gap being within 0.05 decibels (dB).

18. The BS of claim 15, wherein the at least one processing device is configured to:
determine a number of retained decoding paths for each remaining index in the information set, excluding the one or more indices that have entropy-based metrics less than the specified entropy-based metric amount, and
assign a list size to one or more of the remaining indices based on corresponding entropy-based metrics and a corresponding number of the retained decoding paths.

19. The BS of claim 15, wherein the set of entropy values for the received signals are generated according to density evolution via Gaussian approximation and stored in a lookup table.

20. The BS of claim 15, wherein the at least one processing device is configured to:
identify bit sequences for the received signals for which entropy-based metrics values are smallest, and
retain the identified bit sequences and removing other bit sequences for the received signals.
